(19) United States
(12) Patent Application Publication
(10) Pub. No.: US 2011/0214526 A1
(43) Pub. Date: Sep. 8, 2011

(54) ACCELERATOR PEDAL FOR A MOTOR VEHICLE AND METHOD FOR OPERATING THE ACCELERATOR PEDAL

(75) Inventors: Dino DEMMA, Ruesselsheim (DE); Ralf WILFERT, Buettelborn (DE); Frank LEOPOLD, Taunusstein-Orlen (DE)

(73) Assignee: GM GLOBAL TECHNOLOGY OPERATIONS LLC, Detroit, MI (US)

(21) Appl. No.: 13/040,589

(22) Filed: Mar. 4, 2011

(30) Foreign Application Priority Data
Mar. 5, 2010 (DE) 102010010400.0

(51) Int. Cl. G05G 1/40

(52) U.S. Cl. 74/560

(57) ABSTRACT

An accelerator pedal for a motor vehicle is provided with a damping element having an adjustment unit. A force that counteracts the movement of a pedal arm of the accelerator pedal may be set via the damping element. The adjustment unit is connected to a control unit and adjusts the damping element as a function of signals of the control unit. The force which counteracts the movement of the pedal arm can thus be set as a function of the operating units connected to the control unit or a sensor on the accelerator pedal.

### CROSS-REFERENCE TO RELATED APPLICATION

This application claims priority to German Patent Application No. 102010010400.0, filed Mar. 5, 2010, which is incorporated herein by reference in its entirety.

### TECHNICAL FIELD

The technical field relates to an accelerator pedal for a motor vehicle having a deflectable pedal arm and having a damping element for generating a force opposing the deflection of the pedal arm. Furthermore, the invention relates to a method for operating an accelerator pedal which has a deflectable pedal arm and a damping element.

### BACKGROUND

Such accelerator pedals are frequently used in current motor vehicles and are known from practice. In operation, the deflection of the pedal arm is detected by a sensor system and its signals are analyzed by a control unit. In these accelerator pedals, the damping element prevents undesired variations of the deflection of the pedal arm. The damping element of current accelerator pedals is typically set once during their production. A readjustment of damping which decreases due to wear is typically not performed, for example.

A problem exists of refining an accelerator pedal of the type cited at the beginning in such a way that it allows individual damping which is a function of the selected intended use. Furthermore, a method is desirable for operating an accelerator pedal, in which the damping is easily adaptable.

### SUMMARY

A damping element has a variable adjustment unit for adjusting the force opposing the deflection of the pedal arm, the variable adjustment unit is connected to a control unit, and the force opposing the deflection of the pedal arm is adjustable as a function of signals of the control unit.

Through this design, the damping of the deflection of the pedal arm can be easily changed during operation and during travel of the motor vehicle. The values for the individual damping desired by the driver of the motor vehicle are preferably stored in a personal menu of a central computer. The strength of the damping can also vary with the provided intended use of the motor vehicle. The accelerator pedal thus allows an individual damping which is a function of the selected intended purpose.

According to an embodiment, the driver of the motor vehicle receives a perceptible feedback on the operating state of the motor vehicle, if the control unit is implemented to detect a selected driving mode of the motor vehicle and if the signals of the control unit are a function of the selected driving mode. In this way, a different force can be applied to the pedal arm in a sport mode than in a comfort mode, for example.

The accelerator pedal may be adapted in a particularly versatile way if the signals of the control unit are a function of the deflection angle and/or the velocity of the change of the deflection angle of the pedal arm. Through this design, for example, in a mode for economic driving, the force opposing the deflection of the pedal arm may be increased in the event of a greater deflection or more rapid pressing down of the pedal arm, while in the sport mode the pedal arm is deflectable using essentially constant force up to the complete deflection. Furthermore, a so-called kick down stop may be simulated using this design, in which the force opposing the deflection of the pedal arm is increased when the pedal arm is pressed down nearly completely and, if this resistance is overcome, an engine/transmission control unit shifts down a gear, for example.

The damping unit could have a hydraulic damper, for example. The force opposing the deflection of the pedal arm may be set particularly precisely according to another advantageous refinement of the invention, however, if the damping element is implemented as a friction clutch and the adjustment unit is implemented to change the pre-tension force of the friction clutch. A friction clutch in which the wear can be compensated for is preferably selected.

A method is provided for operating an accelerator pedal having a deflectable pedal arm and a damping element, in which the damping is easily adaptable, is solved according to an advantageous refinement of the invention in that a variable adjustment unit activates the damping element, the force opposing the deflection of the pedal arm is variable, and a control unit is connected to the variable adjustment unit, so that the force opposing the deflection of the pedal arm is adjusted as a function of the signals of the control unit.

Through this design, the damping of the deflection of the pedal arm may be easily adapted using the signals of the control unit. The adaptation can be fixed by nearly arbitrarily selected influencing factors. The activation of the adjustment unit is preferably not performed abruptly, but rather slowly rising.

According to an embodiment, the method allows a particularly versatile adaptation of the damping of the pedal arm if the activation of the adjustment unit is performed as a function of the deflection angle of the pedal arm and/or the velocity of the change of the pedal arm.

Upon the activation of an automatic cruise control, the travel velocity is automatically kept constant. In order that the automatic cruise control is not unintentionally influenced, the driver typically sets down his foot adjacent to the accelerator pedal. However, this can have the result that the brake pedal is sometimes not reachable rapidly enough. Unintentional deflection of the pedal arm may be easily avoided according to another advantageous refinement of the invention if the force opposing the deflection of the pedal arm is increased upon the activation of an automatic cruise control. Through this design, the driver can set his foot on the accelerator pedal when he has activated the automatic cruise control. The brake pedal is at the typical distance from the foot and can therefore be reached rapidly. According to an embodiment of the invention, the deflection of the pedal arm is opposed by an increased force, whereby it is ensured that the automatic cruise control is not unintentionally influenced. However, if the driver wishes to intentionally influence the automatic cruise control, he can deflect the pedal arm using increased force.

According to another embodiment, the accelerator pedal may be particularly comfortably operated if the increase of the force opposing the deflection of the pedal arm is reduced upon the deactivation of the automatic cruise control.

It contributes to further increasing the comfort during the operation of the accelerator pedal according to another embodiment if the activation of the automatic cruise control and the performed increase of the force opposing the deflection of the pedal arm is cancelled when the pedal arm is pressed down.

According to another embodiment, in a sport mode, the driver receives direct feedback of his driving if the force opposing the deflection of the pedal arm is increased in relation to a base value upon the selection of a sport mode.

A motor vehicle having the accelerator pedal may be driven in a particularly relaxed manner according to an embodiment if the force opposing the deflection of the pedal arm is reduced in relation to a base value upon the selection of a comfort mode.

The motor vehicle which has the accelerator pedal operated using the method may be individually adapted easily according to another embodiment if the base value of the force opposing the deflection of the pedal arm and/or the amount in relation to which the force is increased or reduced is settable by the driver. The setting of the base value is preferably performed via a menu which is provided in any case in a central computer of the motor vehicle.

### BRIEF DESCRIPTION OF THE DRAWINGS

The present invention will hereinafter be described in conjunction with the following drawing figures, wherein like numerals denote like elements, and:

FIG. 1 schematically shows an accelerator pedal having a control unit; and

FIG. 2 shows a flow chart of a method for operating the accelerator pedal.

### DETAILED DESCRIPTION

The following detailed description is merely exemplary in nature and is not intended to limit application and uses. Furthermore, there is no intention to be bound by any theory presented in the preceding background or summary or the following detailed description.

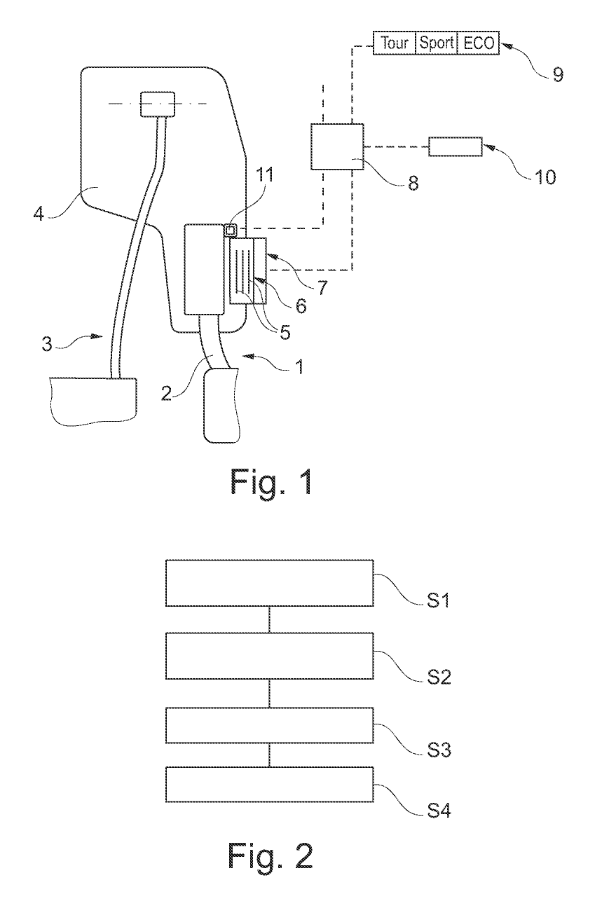

FIG. 1 schematically shows an accelerator pedal 1 of a motor vehicle having a pedal arm 2, which is deflectable perpendicularly to the plane of the drawing. A brake pedal 3 is situated adjacent to the accelerator pedal 1. The accelerator pedal 1 and the brake pedal 3 are mounted so they are pivotable on a shared carrier 4 and are pre-tensioned in a base position, from which they may be pressed down. A damping element 6, which is implemented as a friction clutch having friction linings 5, is situated on the accelerator pedal 1. The damping element 6 has a variable adjustment unit 7 for the pre-tension of the friction linings 5. The adjustment unit 7 is connected to an electronic control unit 8. The electronic control unit 8 additionally has a connection to an operating unit 9 for selecting various driving modes and to a second operating unit 10 for an automatic cruise control. A sensor 11, which is situated on the accelerator pedal 1, is used to detect the deflection angle of the pedal arm 2.

In the event of a high pre-tension of the friction linings 5, a high force opposes the deflection of the pedal arm 2, while in the event of a low pre-tension of the friction linings 5, the deflection of the pedal arm 2 is opposed by a low force. The variable adjustment unit 7 generates the pre-tension of the friction linings 5 as a function of signals of the control unit 8. The activation of the adjustment unit 7 by the control unit 8 is performed as a function of the selected driving mode and the activation or deactivation of the automatic cruise control. Furthermore, the control unit 8 is capable of detecting the deflection angle and the velocity or the acceleration of the pedal arm 2 as a function of the signals of the sensor 11 on the accelerator pedal 1. In this way, the control unit 8 can set the respective force which opposes the movement of the pedal arm 2 as a function of the signals of the sensor 11 and the operating units 9, 10.

In one embodiment (not shown), the damping elements 6 is implemented as a hydraulic element, for example, having a hydraulic cylinder. The adjustment unit 7 is used to adjust flow cross-sections in the hydraulic element.

FIG. 2 schematically shows a method for operating the accelerator pedal from FIG. 1. In a first step S1, it is detected which operating mode is selected via the operating unit 9 and whether the automatic cruise control was activated via the second operating unit 10. In a further step S2, the deflection angle of the pedal arm 2 of the accelerator pedal 1 is detected via the sensor 11. The control unit 8 calculates the force opposing the further deflection of the pedal arm 2 in a further step S3 and activates the adjustment unit 7 in a further step S4.

An embodiment was explained as an example in the preceding description. In addition, manifold further embodiments exist, which have not been mentioned. However, no restriction of the protective scope, the application, or the embodiment of the invention of any type is intended by the description of only one or also multiple exemplary embodiments. The preceding description is merely to give a person skilled in the art an introduction which allows him to implement in the way described. In addition, further changes in the functions and the configuration of the described elements of the exemplary embodiments are conceivable without leaving the protective scope as determined by the patent claims and the equivalents thereof. Moreover, while at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An accelerator pedal for a motor vehicle, comprising:
a deflectable pedal arm; and
a damping element configured to generate a force opposing a deflection of the deflectable pedal arm, the damping element comprising a variable adjustment unit configured to adjust the force opposing the deflection of the deflectable pedal arm, the variable adjustment unit connected to a control unit, and the force opposing the deflection of the deflectable pedal arm is adjustable as a function of signals of the control unit.

2. The accelerator pedal according to claim 1, wherein the control unit is configured to detect a selected driving mode of the motor vehicle and the signals of the control unit are a function of the selected driving mode.

3. The accelerator pedal according to claim 1, wherein the signals of the control unit are a function of a deflection angle of the deflection angle of the deflectable pedal arm.

4. The accelerator pedal according to claim 1, wherein the signals of the control unit are a function of the velocity of change of a deflection angle of the deflectable pedal arm.

5. The accelerator pedal according to claim 1, wherein the damping element is a friction clutch and the variable adjustment unit is configured to change the pre-tension force of the friction clutch.

6. A method for operating an accelerator pedal having a deflectable pedal arm and a damping element, comprising:
activating the damping element with an adjustment unit;
varying a force opposing a deflection of the deflectable pedal arm;
connecting a control unit to the variable adjustment unit; and
adjusting the force opposing the deflection of the deflectable pedal arm as a function of the signals of the control unit.

7. The method according to claim 6, wherein the activating is performed as the function of a deflection angle of the deflectable pedal arm.

8. The method according to claim 6, wherein the activating is performed as the function of the velocity of change of the deflectable pedal arm.

9. The method according to claim 6, further comprising increasing the force opposing the deflection of the deflectable pedal arm upon activation of an automatic cruise control.

10. The method according to claim 9, further comprising reducing the increase of the force opposing the deflection of the deflectable pedal arm upon deactivation of the automatic cruise control.

11. The method according to claim 9, wherein the increase of the force opposing the deflection of the deflectable pedal arm occurs through the activation of the automatic cruise control is cancelled upon pressing down of the deflectable pedal arm.

12. The method according to claim 6, further comprising increasing the force opposing the deflection of the deflectable pedal arm in relation to a base value upon the selection of a sport mode.

13. The method according to claim 6, further comprising reducing the force opposing the deflection of the deflectable pedal arm in relation to a base value of on the selection of a comfort mode.

14. The method according to claim 13, wherein the base value of the force opposing the deflection of the deflectable pedal arm in relation to which the force is adjusted is settable by a driver.

15. The method according to claim 13, wherein the base value of the force opposing a deflection amount in relation to which the force is adjusted is settable by a driver.
